(19) United States
(12) Patent Application Publication
(10) Pub. No.: US 2018/0192575 A1
(43) Pub. Date: Jul. 12, 2018

(54) TOWED IMPLEMENT WITH AUTO CENTER STEERING

(71) Applicant: CNH Industrial Canada, Ltd.., Saskatoon (CA)

(72) Inventors: Matthew R. Sudbrink, Metamora, IL (US); James W. Henry, Saskatoon (CA)

(73) Assignee: CNH Industrial Canada, Ltd., Saskatoon (CA)

(21) Appl. No.: 15/403,389

(22) Filed: Jan. 11, 2017

(51) Int. Cl. A01B 69/00; B62D 6/00; B62D 15/02

(52) U.S. Cl. CPC A01B 69/004; B62D 15/025; B62D 6/00

(57) ABSTRACT

A steerable towed implement towed by a tractor receives manual operator inputs to steer between right and left stop limits and a neutral position. The implement is steered by an actuator controlled by an actuator control system that causes the actuator to bring the implement to a neutral position in the absence of operator control inputs after a given period of time.

### BACKGROUND OF THE INVENTION

### 1. Field of the Invention

The present invention relates to towed agricultural implements, and more specifically to steerable towed implements.

### 2. Description of the Related Art

As agricultural technology advances toward greater efficiencies, the need for a greater lateral reach of an implement becomes increasingly important. This is because a single pass will result in a greater area being either tilled, planted or harvested. With such significant lateral spans, it becomes necessary for an implement that is towed to have steering to enable the tractor or other towed vehicle to negotiate around obstacles and through tight corners. Typically, this is done with a set of actuators, usually hydraulic, operating on steerable wheels for the implement and that are controlled through a hydraulic control system located on the tractor. In simplified form, the implement steering is in response to direct operator input from the tractor operator to negotiate turns at the end of a pass in the field or to negotiate around obstacles. As the operator negotiates a corner, the operator then lines up the implement for another pass and in this case is busy with a number of inputs, including the steering of the towed implement to a neutral position.

It has been proposed in a number of systems to provide elaborate control systems responsive to a great many inputs to return the implement steering to a neutral position. These systems respond to a variety of parameters including implement velocity and other operational factors. While they do provide a measure of self-centering, they do so with greatly increased complexity and cost.

Accordingly, what is needed in the art is a simplified system for returning a steerable towed implement to a center position.

### SUMMARY OF THE INVENTION

The present invention seeks to bring a towed steerable implement to a neutral position in a simplified and cost effective fashion.

In one embodiment, an implement steering system is provided for use with a towable implement. The system includes an actuator connected to at least one steerable axle on the towable implement and an actuator control system connected to the actuator for executing steering commands of an operator between right and left stop limits and a neutral position. A sensor is connected to the actuator to generate a signal to the actuator control system proportional to the position of the actuator between the right and left limits and a neutral position reflecting straight ahead steering of the towable implement. The actuator control system is configured to receive signals from the sensor to control the actuator to its neutral position in the absence of an operator control input.

In another embodiment, a towing vehicle is provided with a towed implement having steerable ground support wheels. Actuators are provided for the steerable wheels to control the direction of the towed implement. The towing vehicle has an actuator control system connected to the actuator for executing steering commands of an operator between right and left stop limits and a neutral position. A sensor is connected to the actuator for generating a signal to the actuator control system proportional to the position of the actuator between right and left limits and a neutral position reflecting straight ahead steering of the towable implement. The actuator control system is configured to receive signals from the sensor to control the actuator to its neutral position in the absence of an operator control input.

Still another embodiment is directed to a method for controlling an implement towed by a tractor and receiving operator steering inputs to steer between a right and left stop limit and a neutral position. The method includes determining whether an operator steering input is provided to the implement and, in the absence of an operator steering input, steering the implement to a neutral position.

One advantage of the present embodiment is freeing an operator to concentrate on aligning a towed implement after a turn or obstacle avoidance maneuver.

Another advantage is providing a simplified and cost effective system to achieve automatic centering of a towed implement.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 is a perspective view, partially schematic, of a towed steerable implement towed by an agricultural tractor;

FIG. 2 is an expanded partial perspective view the towed steerable implement of FIG. 1 with one form of a position sensor; and,

FIG. 3 is an expanded partial perspective view the towed steerable implement of FIG. 1 with another form of a position sensor

The exemplification set out herein illustrates one embodiment of the invention and such exemplification is not to be construed as limiting the scope of the invention in any manner.

### DETAILED DESCRIPTION OF THE INVENTION

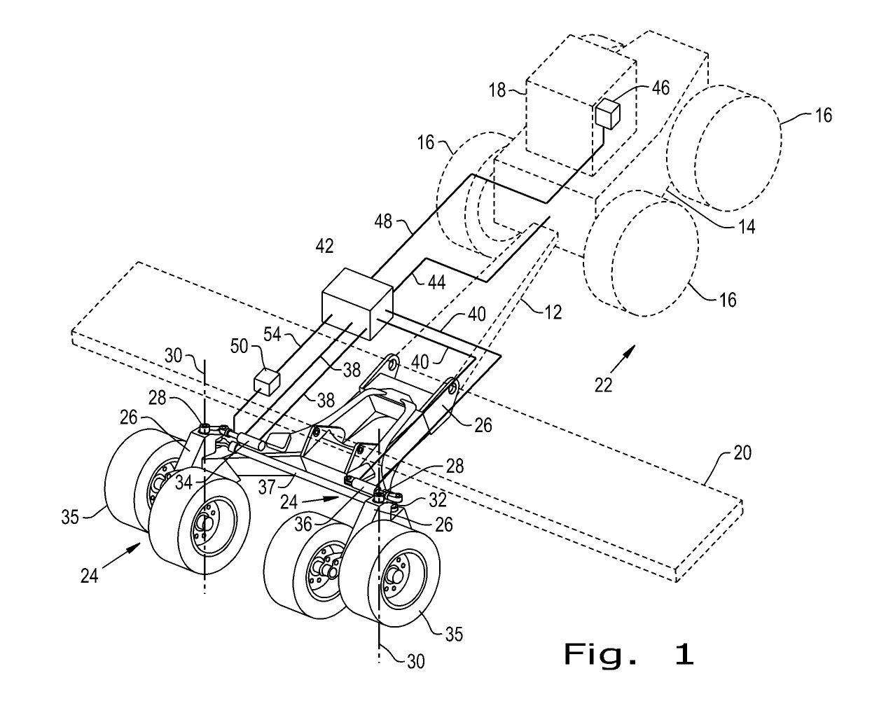

Referring now to the drawings, and more particularly to FIG. 1, there is shown an implement 10, partially shown in schematic fashion, having a hitch 12 for connection with a towing vehicle such as a tractor 14. Tractor 14 has ground drive wheels 16, some or all of which may be powered and/or steerable, to direct the tractor 14 through a field and pull the implement 10 behind it. Implement 10 may be one of a number of implements including cultivators and planters. For this purpose, a frame 20 extends laterally with respect to the direction of travel 22. The frame 20 may be foldable through a variety of articulations to place the implement either in a field position (illustrated) and a transport position where the lateral length of the frame is displaced to be generally parallel to hitch 12 for transport purposes. The frame 20 may support seeding units or ground engaging components as required. These are not shown to enable a better focus on the embodiment illustrated.

The frame 20 is supported by a pair of wheel assemblies 24 each having a wheel assembly frame 26 connected to frame 20 in a fashion that permits upwards and downward movements relative to frame 20 so as to control the depth of penetration of the cultivator ground engaging components or seeding units carried by the frame 20. Each wheel assembly frame 26 has a steerable wheel mounting 28 about a vertical pivot axis 30 through crank arms 32. A left actuator 34 and right actuator 36 are connected to the crank arms 32 to provide synchronized steering of the wheels 35 through a tie bar 37.

Left and right actuators 34 and 36 are illustrated as hydraulic. It should be apparent, however, to those skilled in the art that the actuators 34 and 36 may be pneumatic or electric as appropriate for a particular control protocol. Left actuator hydraulic lines 38 and right actuator hydraulic lines 40 lead to an implement control module 42 (also referred to as UCM or Universal Control Module) that directs hydraulic pressure to the left and right actuators 34 and 36, as appropriate, to steer the wheel assemblies 24 and thus the frame 20. The implement control module 42 is provided with pressurized hydraulic fluid from the tractor 14 by a line 44. An operator control module 46, positioned in operator cab 18 on tractor 14, sends command signals to the implement control module 42 through line 48. Although one line is illustrated, it should be apparent that more than one line may be utilized according to the control protocol.

In operation, the operator in cab 18 directs the tractor 14 through a field and can provide manual inputs to the implement steering by the operator control module 46. The actuator control system is connected to the actuators 34 and 36 for executing steering commands of an operator between right and left stop limits and a neutral position in between the right and left stop limits. The neutral position is approximately halfway between the right and left stop limits but may be either side depending upon the crown of a roadway or the ground over which the implement is towed.

In the illustrated simplified form, the operator control module 46 utilizes manual inputs from the operator to steer implement 10 at the end of a pass to achieve a tighter turning radius or to avoid an obstacle. In the case of turning at the end of a pass, the operator, in this simplified manual steering, must not only bring the implement 10 to the field towed position but must accurately steer the tractor 14 onto the adjacent rows. With prior art simplified steering systems, the overload of control movements may cause tracking of the implement to be difficult.

In accordance with a present embodiment, the control system set forth below allows for unassisted centering of the implement after an end of a pass. Continuing to refer to FIG. 1, a steering position sensor 50 (shown schematically) is mounted on frame 20 and has position sensor connections 52, shown as a dashed line, to one or both of the left and right actuators 34 and 36.

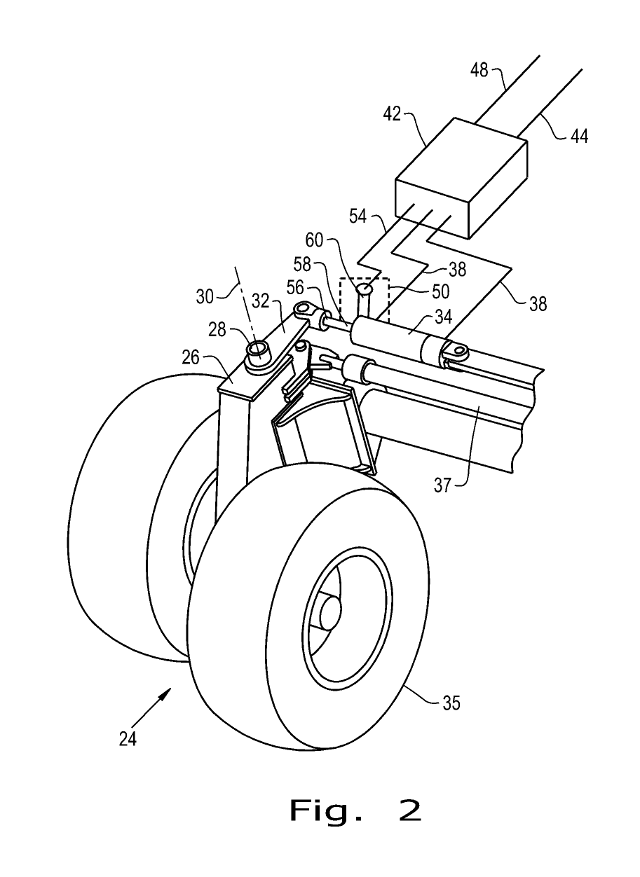

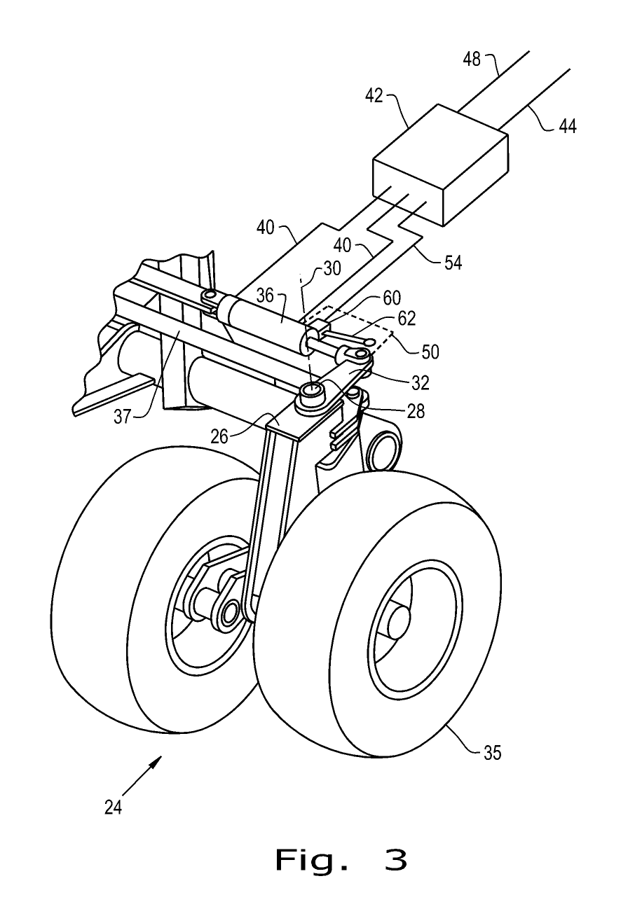

As shown in FIGS. 2 and 3, the position sensor 50 may take any one of many forms. Referring to FIG. 2, the actuator output shaft 56 has magnetic encoding at 58. A sensor 60 mounted on actuator 34 reads the encoding to send a signal reflecting the actual steering position to the implement control module 42 via line 54. In FIG. 3, a potentiometer 62, connected to the actuator 36, has a potentiometer input component connected to an actuator output shaft 66 to generate a resistance signal on line 54 proportional to the position of the actuator. Thus, the implement control module 42 receives an input reflecting the actual position of the steering. The actual position of the steering is manually controlled from the operator control module 46 during any field operation and into a corner. The implement control module 42 is configured, however, to provide a correcting signal to center the wheel assemblies 24 in the absence of an operator control input from operator control module 46. Preferably the self-centering process would take place in the absence of an operator input for a period of approximately 1.5 to 3 seconds so as to reflect the absence of operator input as the operator is executing a turn and steering the tractor 14 towards a new path in the field.

The above apparatus provides autosteering only when needed, thus allowing for a simplified control system in lieu of complicated control schemes which incorporate expensive components and software execution. As a result, an operator is provided with an automatic self-centering feature on a simplified steering assembly with its associated less costly acquisition and simplified operation.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An implement steering system for use with a towable implement, said system comprising:
an actuator connected to at least one steerable axle on said towable implement;
an actuator control system connected to said actuator for executing steering commands of an operator between right and left stop limits and a neutral position between the right and left stop limits;
a sensor connected to said actuator generating a signal to said actuator control system proportional to the position of said actuator between right and left limits and said neutral position reflecting straight ahead steering of said towable implement; and
wherein said actuator control system is configured to receive signals from said sensor to control said situations in said neutral position in the absence of an operator control input.

2. The implement steering system as claimed in claim 1, wherein said control system is configured to control the actuator to said neutral position in the absence of an operator input for a given period of time.

3. The implement steering system as claimed in claim 2, wherein said period is approximately between 1.5 and 3 seconds.

4. The implement steering system as claimed in claim 1, wherein said actuator is a hydraulic actuator and said sensor generates a signal reflecting the position of said actuator.

5. The implement control system as claimed in claim 4, wherein said sensor is one of a sensor detecting a magnetic encoding to reflect extension of said actuator and a potentiometer generating a resistance signal reflecting extension of said actuator.

6. The implement steering system as claimed in claim 1, wherein having a pair of steerable wheel assemblies on said towable implement.

7. The implement control system as claimed in claim 1, wherein said actuator control system includes an implement control module for controlling said actuator.

8. An agricultural implement comprising;
a tractor steerable by operator inputs for traversing a field;
an implement towed by said tractor and having a frame including a hitch for connecting to said tractor;
a frame extending laterally for mounting agricultural components;
at least one steerable wheel assembly on said implement for directing the path of said implement behind said tractor;
an actuator connected to said at least one steerable wheel assembly;
an actuator control system connected to said actuator for executing steering commands of an operator between right and left stop limits and a neutral position between the right and left stop limits;
a sensor connected to said actuator for generating a signal to said actuator control system proportional to the position of the actuator between right and left limits in said neutral position reflecting straight ahead steering of said towable implement; and,
wherein said actuator control system is configured to receive signals from said sensor to control said steerable axles to said neutral position in the absence of an operator control input.

9. The agricultural implement as claimed in claim 8, wherein said actuator control system is configured to control the steerable axles to said neutral position in the absence of operator control signals for a given period of time.

10. The agricultural implement as claimed in claim 9, wherein said given period of time is between approximately 1.5 and 3 seconds.

11. The agricultural implement as claimed in claim 8, wherein said actuator is a hydraulic actuator and said sensor determines the position of said actuator.

12. The agricultural implement as claimed in claim 11, wherein said sensor is one of a sensor detecting a magnetic encoding to reflect extension of said actuator and a potentiometer generating a resistance signal reflecting extension of said actuator.

13. The agricultural implement of claim 8, having a pair of steerable wheel assemblies.

14. The agricultural implement as claimed in claim 8, wherein said actuator control system includes an implement control module on said implement for executing said steering commands.

15. A method of controlling an implement towed by a tractor and receiving operator steering inputs to steer between a right and left stop limit and neutral position between the right and left stop limits, said method comprising the steps of:
determining whether an operator steering input is provided to the implement; and,
in the absence of an operator steering input steering the implement to said neutral position.

16. The method as claimed in claim 13, wherein the step of determining the absence of the steering input is after a given period of time.

17. The method as claimed in claim 14, wherein said given period of time is between approximately 1.5 and 3 seconds.
